(19) United States
(12) Patent Application Publication
(10) Pub. No.: US 2008/0091780 A1
(43) Pub. Date: Apr. 17, 2008

(54) Integrated secure mobile collaborative environment that facilitates structured data capture and communication

(76) Inventors: Ramesh Balan, Frisco, TX (US); Vijay Balakrishnan, Plano, TX (US); Kuzhali Srinivasan, Irving, TX (US); Nawsheeo Haq, Irving, TX (US)

Correspondence Address: RG & ASSOCIATES, 1103 TWIN CREEKS, STE. 120, ALLEN, TX, 75013, US

(21) Appl. No.: 11/890,434

(22) Filed: Aug. 6, 2007

Related U.S. Application Data
(60) Provisional application No. 60/835,546, filed on Aug. 5, 2006.
(60) Provisional application No. 60/835,549, filed on Aug. 5, 2006.

(51) Int. Cl. G06F 15/16

(52) U.S. Cl. 709/204

(57) ABSTRACT

A method, system, and computer readable medium comprising instructions to build a configurable electronic forms messenger (EFM) system which includes a configuration module and an EFM module. Each of these modules has its own client and server components and both share a common EFM data store. These components enable businesses to perform the following operations: Capture and process data using electronic form templates Configure workflows and automate form template transmission Improve collaboration between users from different locations, hierarchies or systems Access and process information in online and offline modes Secure information from unauthorized tampering

### CROSS REFERENCE TO RELATED APPLICATIONS

The present invention is related to and claims priority from provisional patent application 60/835,546, filed on Aug. 5, 2006, and titled Method And System Of Creating An Integrated Secure Mobile Collaborative Environment That Facilitates Structured Data Capture And Communication, and from provisional patent application 60/835,549, filed Aug. 5, 2006, and titled Set Of Methods To Create And Consume Complex Business-Rule-Encoded Electronic Form Templates To Collect, Store, Retrieve And Manage Data In A Secure And Efficient Manner, the entire content of each of which are incorporated by reference herein.

### FIELD OF THE INVENTION

This invention relates generally to the field of computer software, and more particularly to an integrated collaborative mobile environment to facilitate structured data communication and collaboration within enterprises. This invention provides enterprises a managed environment to automate the capture, management, sharing, tracking, storage and retrieval, and auditing of information, while providing seamless connectivity to back-end databases and other applications. This invention also relates to the fields of business process management or automation, forms automation, mobility enablement platforms and configurable application platforms that enable distributed enterprise applications.

### BACKGROUND

Collaboration and communication between workers has improved over the years through the use of technology—beginning with telephony, fax, and electronic mail to instant messaging, the increasing use of technology has resulted in improved productivity. Electronic collaboration methods in the past have largely been unstructured. For the purpose of this document, unstructured communication is defined as free-form capture and exchange of information. Such unstructured communication does not permit the incorporation of sophisticated business rules such as data validation rules, automatic routing of information, storage and retrieval of captured data into and from one or more database tables, etc. When the collaboration process takes place according to a set of pre-determined business rules, including data validation, roles and privileges based on users or user-groups, routing of information between users, etc., it is defined as structured collaboration. Structured forms of collaboration deliver greater levels of security, operational control and efficiency, and hence overall productivity and manageability than do unstructured ones.

Structured data capture is typically accomplished using electronic form template documents. While a number of currently available tools allow enterprises to build and consume form templates, it is challenging to incorporate validation and workflow rules specific to a given business into such packaged applications. It is even more challenging to provide a managed and controlled environment in which enterprises can easily configure and operate such collaborative applications that combine the power of structured data collaboration features with the simplicity and universality of an email platform. It is equally challenging to accomplish this while retaining the experience of using paper and pen that users are familiar and comfortable with.

Another important factor to be considered in the reality of today's business environment is the demand for professionals to work remotely. Workers face increasing demands for work outside the office and a growing need to be productive immediately instead of waiting until they return to their home bases. Unfortunately, the typical solution to this problem, a browser-based remote application, falls short of equipping mobile workers to meet the above challenges. This is because a web application is only as good as the mobile user's connection to the application. The connectivity available to mobile workers is often of poor quality and in some cases, completely absent.

A complete structured collaboration and communication system should enable the following:
Creating, managing and distributing form template documents using a non-programmatic configuration tool that can be used even by lay-persons (instead of a programming tool like Microsoft Visual Studio® which requires high levels of technical expertise)
Incorporation of data validation rules, ability to configure user defined roles and privileges to control access to data
Data collection, manipulation, storage and retrieval
Mobile collaboration: allowing users to access their data, or collaborate with one another in both offline and online modes, and to enforce business and other validation rules, even when users are in offline modes.
Workflow automation: allowing for automatic transmission of data between different users or departments within an organization
Automatic management of multiple versions of data at the desktop, automatic organization of data

Currently there is no single application that addresses all of these needs. Even when users rely on a combination of one or more applications, they face significant disadvantages. Custom business process automation solutions offer only IT-driven solutions to improve collaboration. These applications are typically very expensive and time-consuming to build and maintain. Also, once a custom application has been built, it is challenging to make even minor modifications to it. Enterprises are forced to spend significant resources to maintain in-house development talent in order to ensure that their application infrastructure keeps pace with their changing business needs. For Small and Medium Businesses (SMBs), such sophisticated custom IT solutions are out-of-reach and unaffordable.

It is an object of this invention to enable users to address all of these problems in a configurable manner, without having to write custom code.

### DESCRIPTION OF RELATED ART

I. Disadvantages Associated with Building Custom Collaboration Applications

As mentioned earlier, there is no single off the shelf software application available in the market today which enables enterprises to easily and inexpensively set up the infrastructure for structured communication and collaboration. Enterprises are forced to rely on custom applications instead. Traditional custom application development is an expensive and time consuming process. Rapidly changing market forces and regulatory requirements demand frequent replacement or upgrades, require organizations to maintain in-house development talent, or to be prepared to outsource such tasks on a frequent basis. Both options are expensive and time consuming. Businesses find themselves continually waiting for the development group to deliver solutions to their requests. Buying a packaged application, also termed as Components-Off-The-Shelf (COTS) method is an alternative to building a custom application. However, this option can be frustrating, costly, and only rarely meets business needs completely.

II. Deficiencies in Currently Available Integrated Collaborative Systems/Forms Automation Software

Examples of popular applications that seek to address some of the problems listed earlier include Microsoft Infopath®, Adobe System®, Verity LiquidOffice®, Mi-Co®, Activeink® etc. A few more are described in more detail below.

Enabling workflow management: Many of these forms applications allow users to create and fill stand-alone form templates. However, in many cases, users need to share information thus captured with other users. The tools listed above do not enable enterprises to automate workflow management. Some custom forms applications do allow organizations to create electronic form routes. However, these routes are pre-set at the time of implementation, and making changes to such routes at a later stage is challenging and demands some level of application development.

In U.S. Pat. No. 6,704,906, Yankovich describes a self-routing forms system where each user in the process defines the next process. While this allows for flexibility, the operation can be cumbersome in large organizations, where there may be a very large number of employees. Yankovich's invention requires the submitting user to provide user names, user ids, or some other designator to the server side application. This makes the application difficult to learn and to use, as users are required to remember a considerable amount of information extraneous to the form being filled. Further, in that invention, routing information exists completely within the electronic form itself. This makes change management difficult, since every form must be altered in case even a single step in the path to be followed by that form needs to be changed. Thus there is a need for providing an easy, more efficient way to set and manage form routes and automate workflows.

Typical automatic workflow solutions, including the one described by Yankovich in U.S. Pat. No. 7,000,179, that allow users to transmit form data among themselves do so at a form level. It is sometimes desirable to transmit only a sub-set of form fields, rather than all the fields in a given form template. At other times it is necessary to transmit different parts of a form to different destinations. For example, upon completing a patient evaluation, a doctor completes a fills out prescription information to be sent to the pharmacy, physical examination information to record the patient's history, along with the relevant insurance information for billing purposes, etc. When automating a patient evaluation form and its workflow, it is desirable to capture all the information in a single form template, and route the appropriate information to the appropriate next level user. In this case, it the form fields pertaining to the prescription are routed to a pharmacy, the billing information to the insurance company and so on. Presently, the only way to accomplish this is to create a separate form for each subset that has a unique set of workflow steps, rather than create one form template with numerous such subsets. In our example, a distinct form template must be created for recording the different types of information—a prescription form, a history form, and a billing form—because there are no known methods to route selective subsets of form fields pertaining to a single form template. This is cumbersome, and inefficient. Users are forced to fill out multiple forms as they perform their duties.

Data is shared not only among users belonging to the same organization, but also between those belonging to different organizations. Industry standards such as Extensible Markup Language (XML) have evolved in order to allow different systems to communicate with one another using a common protocol. It is the responsibility of the application developer to build applications in a way that a given application can accept inputs from external systems created using an industry standard, and provide output to external systems in the same format. However, for every new application with which a given application interacts with, a different connector program must be developed. This makes applications expensive to extend across multiple organizations.

It is all the more challenging to address the problems listed above in a mobilized environment, one that is accessed by mobile workers who operate from anywhere. Browser-based web applications can address some of these problems. Recently, applications have started to be viewed as services, with several companies including, www.salesforce.com which rely on service-oriented architectures and follow a ‘software-as-service’ model. However, these applications demand connectivity to the internet in order to function. Despite wireless technology, the quality of connectivity available to mobile workers is inconsistent or not available at all.

It is an object of this invention to enable users to overcome these deficiencies, without requiring them to undergo expensive application development steps.

### SUMMARY OF THE INVENTION

Definitions of terms used in this document:
1. The term “system” is used to refer to a computer-based system that offers enterprises a managed environment to automate the capture, management, sharing, tracking, storage and retrieval, and auditing of information, while also providing seamless connectivity to back-end databases and other applications. This invention also enables business process management or automation, forms automation, mobility enablement platforms and configurable application platforms that enable distributed enterprise applications. An example of such a system is described in the present specification.
2. The terms “Designer module” and “Forms Designer” are used interchangeably and represent the environment where form templates are built.
3. The term “form template” represents an electronic document or file having a preset format (essentially a meta-data structure defined using the Designer Module), and which is used as a starting point to collect a pre-determined set of information. The template serves as basis for collecting data, and contains one or more fields.
4. The terms “template capsule” and “form template capsule” are used interchangeably and represent a collection of one or more form templates.
5. The term “field” signifies an object with a specific position and dimensions that can accept a user input. Fields can accept many kinds of user input, including but not limited to text, numbers, date, time, free-form writing, selections etc. The spatial positions as well as dimensions of fields are determined by the user.
6. The terms “Editor Module”, “Forms Editor” and “Editor” are used interchangeably and represent the environment where users fill forms.
7. The term “form instance” refers to an instance of the form template created using the Forms Editor. Any number of form instances can be created for a given form template.
8. The term ‘node’ refers to both a source from which a form instance originates, as well as a destination to which a form instance is directed to. Sources and destinations are composed of either individual or groups of users. Nodes are used when defining the workflow for a form template or a document package.
9. The terms “route” and “step” are used interchangeably and signify the path followed by an electronic form as it is transmitted between nodes.
10. The term domain is used to refer to a group of users whose networked computers share a common communications address. In practice, a domain could be composed of all the users in an enterprise or a department, etc.

### SUMMARY

This invention presents a new method, system, and computer readable medium to improve structured communication and collaboration within organizations. The ‘integrated mobile collaborative environment’ described by this invention treats applications as networks and represents a new approach to building and deploying configurable applications. Viewing applications as networks allows them to be developed more efficiently, and faster. The following table compares the characteristics of distributed applications with those of networks:

| Distributed Applications | Networks |
|---|---|
| Typically involves assembling | Typically involves assembling |
| packaged software and custom | Out-Of-The-Box components and |
| software | some custom configuration |
| Made of client software, | Made of server nodes, client |
| server software, databases, | devices, and connection |
| and external applications | between nodes |
| Altering behavior of the | Altering behavior of the network |
| application requires | requires modifications to the |
| modifications to software, | network configuration settings, |
| which is typically an | which is typically a lower-cost |
| expensive proposition | proposition |

This invention relies on the above approach to build an electronic forms messenger system, which enables structured communication and collaboration within enterprises. Such a system enables enterprises to easily accomplish the following:
Easily and inexpensively build configurable collaborative environments for structured communication and collaboration
Standardize creation, distribution and transmission of form templates
Secure form data from unauthorized tampering
Enable users to access forms and other information even when the user is operating in an offline mode
Readily configure and manage workflow routes between users of the same organization and also between users belonging to different organizations.

This invention enables enterprises to extend back-office capabilities to the edges of a business, as illustrated in the following scenarios:
a) a mobile worker, operating from a location outside the office can access back-office applications even from locations where the worker's connectivity to these applications is poor or absent
b) users in a given enterprise collaborate directly with those from the enterprise's partners and vendors. For example: a staff member from a consulting physician's office is directly able to access a hospital's system to reserve an operating room. Currently, such users are unable to directly access applications across organizations, and hence unable to collaborate with users from different organizations.
c) enabling access to back-end applications to any other users who are unable to use such applications due to performance-related issues, or poor user interface (for example: back office system requires users to type, when it is preferable to handwrite inputs), or poor availability of the overall system.

Note that the scenarios described above are illustrative and not exhaustive. The scope of application of this system is well beyond these scenarios, and applies to any situation where a group of users within or external to an enterprise needs to conduct mobile data collaboration with a controlled, managed environment.

This invention allows businesses to extend existing back-office infrastructure to the edges of a business as well as build back-office infrastructure if one does not already exist. Refer to FIG. 100 for an overview of a pictorial representation of the electronic forms messenger system proposed by this invention.

The electronic forms messenger (EFM) system comprises the following:
Configuration client
Configuration server
EFM data store
EFM server
EFM client
Client-side cached data store for the EFM client module

Auxiliary components include databases for the storage of application information, and an application configuration repository which stores the core intelligence for the network including business rules, data validation rules, workflow and routing configuration, form and document templates, security roles and privileges. This invention also works with external applications and data sources supporting other business processes.

The configuration client and server modules and their sub-components allow administrative users to configure various aspects of the electronic forms messenger (EFM) system, including the following:
1. Designing and configuring electronic form templates: The Forms Designer Module provides the environment in which form templates are designed. Refer to FIG. 600 for a pictorial representation of the Designer Module.
2. Configuring routes for electronic form templates: The Configuration manager allows users to set workflow routes for form templates, and directs filled out forms between different users and user groups. Refer to FIG. 900 for a pictorial representation of the Configuration manager.
3. Creating and managing users, users groups, as well as privileges and rights associated with them. Refer to FIGS. 300 through 500 to view the interface provided for management of users and user groups.

The EFM server and client modules are used by end users to capture information using the electronic form templates and to route this information amongst themselves. The user interacts with the system through the EFM client. The configuration information defined by the administrative user is enforced by the EFM client. The various functions performed by the EFM Client include the following:
1. Filling forms: The Forms Editor Module is the environment in which instances of forms templates are created and filled. FIGS. 1300 and 1400 depict how the Forms Editor Module enables users to capture different kinds of information using electronic form templates.
2. Organizing forms and related information: The EFM Client automatically organizes form templates and form instances under various folders. The organization of the various folders is depicted pictorially in FIG. 1000. The ‘My Workflow’ folder is used to store form instances created by a given user or received by the given user from other users. The ‘My Folders’ area allows the user to define any number of folders and sub-folders (similar to the folders that can be created using the Windows® Operating System). This area is used to store any electronic document, including but not limited to MS Office® documents. The end user can import any relevant document from the operating system's folders into any folder in the ‘My Folder’ area. Refer to FIGS. 1100 and 1200 to view screen captures of My Workflow and My Folder areas in an embodiment.
3. Searching and retrieving historic information: In this system, once a form has completed its life cycle, (i.e.) all necessary information has been filled; the form data is stored into the EFM data store or an external application data store, if one exists. The EFM client provides the interface using which, end users can look for and retrieve data from the EFM or other data stores for reference at a later point.
4. Send and receive form capsules: The EFM Client is the interface available to the user to not just fill forms, but also pass form to and receive forms from other users in the system. Whenever the user is ready to pass a form to the next user in the system, the EFM Client is responsible for passing the capsule containing the form instance to the EFM Server, which determines the identity of the recipient of the capsule. If the EFM Server has one or more form capsules available for a given user, the EFM Client of that user receives these capsules whenever it connects with the EFM Server.
5. In addition to the above, the EFM Client may have a number of optional capabilities including but not limited to the following: instant messaging, electronic planner, messages, etc.

The various functions of the EFM server include the following:
1. Pass form templates and template capsules to EFM Client when form templates are published. The configuration information for any capsule which is stored on the EFM Data store contains the list of users who are privileged to access a given capsule. The EFM Server passes capsules to EFM Clients based on the configuration information associated with these capsules.
2. Extract data from form instances and store copies of the data into the EFM Data Store.
3. Automate form workflow: The EFM Server operates as a workflow engine and hands off all form capsules it receives to the EFM Client that is next in line to receive the capsule. The route to be followed by a given capsule is stored as part of the routing information in the EFM Data Store.

How the Configuration and EFM components work together to enable structured communication and collaboration is depicted in FIG. 200. In the next section, we will consider the above components in greater detail.

In one embodiment of the present invention, a system comprises a configuration client, a configuration server communicably coupled to the configuration client, an electronic forms messenger (EFM) client, an EFM server communicably coupled to the EFM client, a data store communicably coupled to the configuration server and to the EFM server, wherein the configuration client is used to: configure at least one of: the EFM client, the EFM server, and the data store, and set various parameters and stores the parameters in the data store, wherein the configuration server module accesses the stored parameters, and wherein the EFM client is used to: download EFM templates, create and manipulate EFM instances as configured using the configuration client.

In another embodiment of the present invention, a system for using an electronic form template document comprises a primary data store, a cached data store, a processor used to create the electronic form template document, wherein the document includes: at least one form field associated with a specific two dimensional spatial position in relation to a point of reference on the electronic form template document, an indication whether none or one or more of the form fields are mapped to the primary data store, an indication whether none or one or more of the form fields are mapped to the cached data store, a primary memory communicably coupled to the processor, wherein the primary memory stores the primary data store, and a secondary memory communicably coupled to the processor, wherein the secondary memory stores the electronic form template document and the cached data store.

In a further embodiment of the present invention, a method for using an electronic form template document comprises producing a first electronic form template document using a user-defined layout, the first electronic form template including: a background reference document, at least one form field associated with a specific two dimensional spatial position in relation to a point of reference on the background reference document, none or one or more validation rules associated with the form field, and producing at least one secondary electronic form template document with a user-defined layout distinct from the layout of the first electronic form template, wherein the secondary electronic form template further includes: a background reference document, at least one form field associated with: a user-defined two dimensional spatial position in relation to a point of reference on the background reference document of the secondary electronic form template, and a user-specified mapping between the form field in the secondary electronic form template and the form field in the first electronic form template.

### BRIEF DESCRIPTION OF THE DRAWINGS

FIG. 100 depicts an overview of an electronic forms messenger system in accordance with an embodiment of the present invention;

FIG. 200 depicts a structured collaboration using electronic forms messenger system in accordance with an embodiment of the present invention;

FIG. 300 depicts creating and editing users in accordance with an embodiment of the present invention;

FIG. 400 depicts creating and editing user types in accordance with an embodiment of the present invention;

FIG. 500 depicts creating and editing users in accordance with an embodiment of the present invention;

FIG. 600 depicts an overview of designer module in accordance with an embodiment of the present invention;

FIG. 700 depicts an interface to set tab properties II in accordance with an embodiment of the present invention;

FIG. 800 depicts an interface to set tab properties II in accordance with an embodiment of the present invention;

FIG. 900A depicts using the configuration manager I—Defining form route and tab privileges in accordance with an embodiment of the present invention;

FIG. 900B depicts using the configuration manager II—Selecting templates and arranging them in a desired sequence in accordance with an embodiment of the present invention;

FIG. 900C depicts using the configuration manager III—Setting user privileges for template capsule in accordance with an embodiment of the present invention;

FIG. 900D depicts using the configuration manager IV—Setting route for template capsule in accordance with an embodiment of the present invention;

FIG. 1000 depicts organization of various folders in the EFM client in accordance with an embodiment of the present invention;

FIG. 1100 depicts organization of workflow folders in the EFM client in accordance with an embodiment of the present invention;

FIG. 1200 depicts organization of user-defined folders in the EFM client in accordance with an embodiment of the present invention;

FIG. 1300 depicts an overview of editor module—I in accordance with an embodiment of the present invention;

FIG. 1400 depicts an overview of editor module—II in accordance with an embodiment of the present invention;

FIG. 1500 depicts methods called by configuration client in accordance with an embodiment of the present invention;

FIG. 1600 depicts methods called by EFM client in accordance with an embodiment of the present invention;

FIG. 1700 depicts setting field level values using configuration manager in accordance with an embodiment of the present invention;

FIG. 1800 depicts a forms publish table in accordance with an embodiment of the present invention;

FIG. 1900 depicts methods called by configuration client when a template is published in accordance with an embodiment of the present invention;

FIG. 2000 depicts a forms re-publish table in accordance with an embodiment of the present invention;

FIG. 2100 depicts methods called by configuration client when re-publishing a template in accordance with an embodiment of the present invention;

FIG. 2200 depicts a forms capsule table in accordance with an embodiment of the present invention;

FIG. 2300 depicts methods called by configuration manager when building or updating a template capsule in accordance with an embodiment of the present invention;

FIG. 2400 depicts a privilege data table in accordance with an embodiment of the present invention; and

FIG. 2500 depicts methods called by configuration manager when setting privileges and by EFM client when receiving privilege information in accordance with an embodiment of the present invention.

### DETAILED DESCRIPTION OF INVENTION

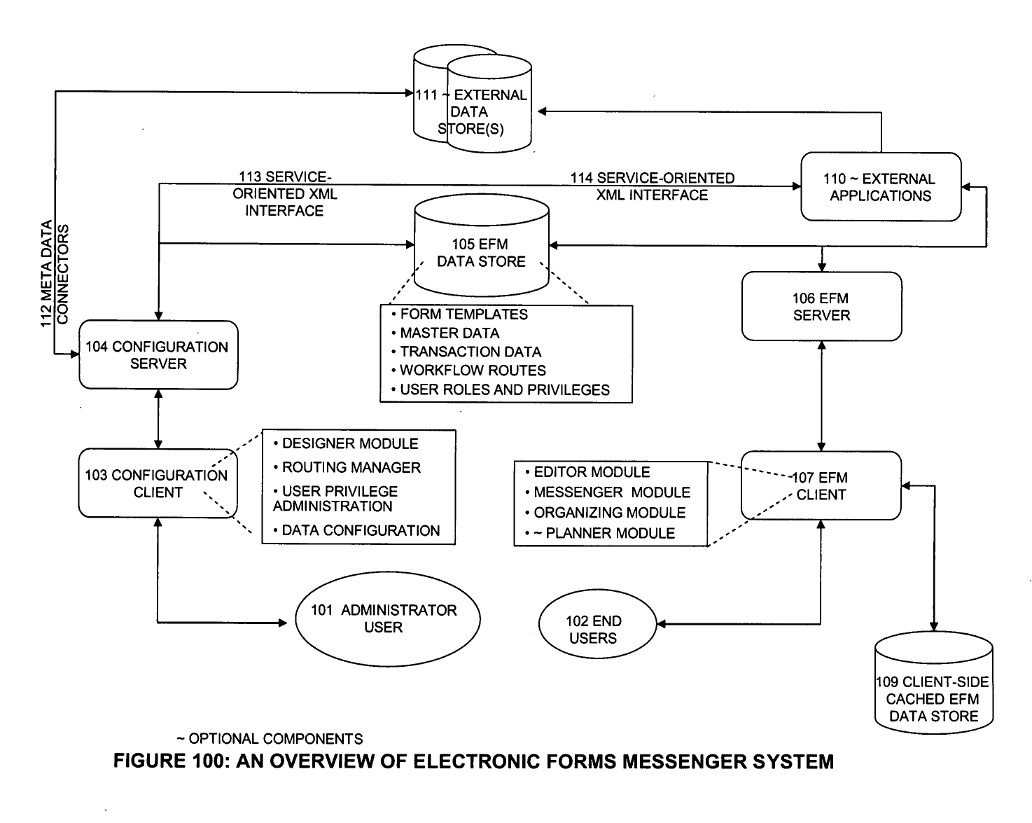

Referring now to FIG. 100, an electronic forms messenger (EFM) system of the present invention is depicted. The system includes a configuration client 103 communicably coupled to a configuration server 104, an EFM client 107 communicably coupled to an EFM server 106, and an EFM data store (or other data store) 105 communicably coupled to the configuration server 104 and to the EFM server 106. The EFM client 107 can be communicably coupled to a cached EFM data store (or other data store) 109 and is typically accessed by end users 102. The configuration client 103, which can be communicably coupled to a data store, is typically accessed by one or more administrative or managerial users. The system may also include external data stores (or memory) 111 communicably coupled to the configuration server 104 wherein metadata connectors 112 interface between the modules 104, 111. Other external applications 110 may also exist and interface with the EFM server 110. Although the system in FIG. 100 is depicted in a specific manner in accordance with one embodiment of the present invention, numerous rearrangements, additional module, or a reduction in modules can occur without departing from the scope of the present invention. A more detailed description of the functionality provided by the modules will be described below.

In this section we will consider the following topics in greater detail:

1. Configuration Client and Server

2. EFM Client and Server

3. Form template design and consumption

4. Configuring form workflow

5. Allowing users to collaborate across domains

Configuration Client and Server

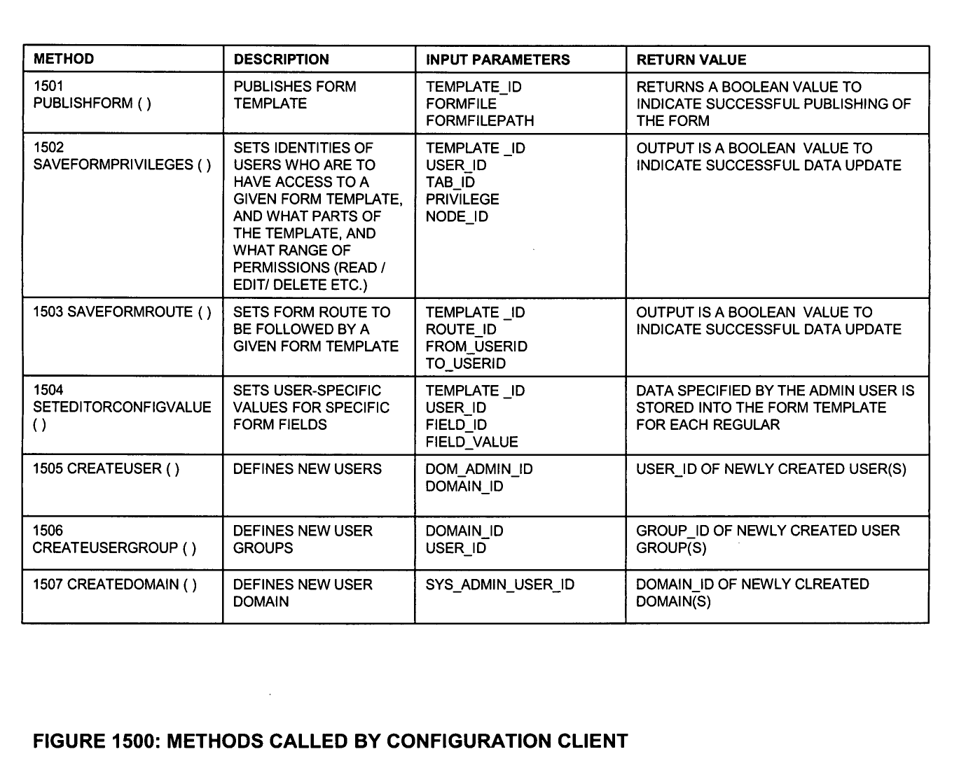

As mentioned earlier, the Configuration Client is the interface used by administrative users to configure the electronic forms messenger (EFM) system. The various components of the Configuration Client were described in an earlier section. Refer to FIG. 1500 for a list of methods called by the configuration client. The various parameters set using the Configuration Client are stored in the EFM data store and accessed by the Configuration Server Module.

EFM Client and Server Modules

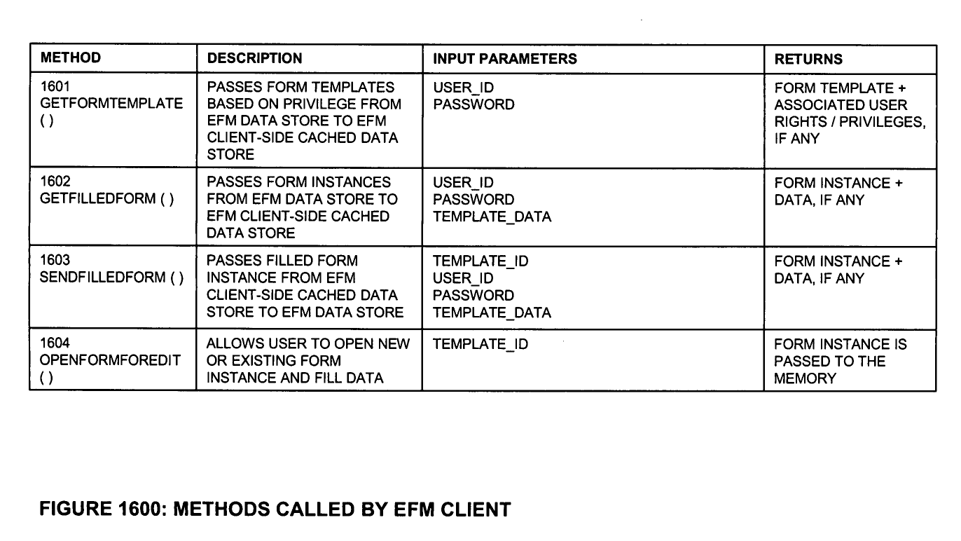

The EFM client is used by non-administrator users of the electronic forms messenger system. The EFM Client allows users to download form templates, create and work on form instances, which can be saved locally or ‘sent’ to the next user on the form-route, as configured using the configuration client. Refer to FIG. 1600 for a list of methods called by the EFM client:

As we consider the various steps involved in enabling structured communication and collaboration using the EFM system, we will understand at what stage the different methods listed in FIGS. 1500 and 1600 are called by the client modules and what is accomplished by those methods. The various steps involved are:

Step 1: Create users and user groups

Step 2: Build form templates

Step 3: Configure EFM System

Step 4: Use EFM system to capture, validate and exchange data

Step 1: Creating Users and User Groups

The first step in building the electronic forms messenger system is to use the interface provided by the Configuration Client 103 to create a set of domains. A domain is a collection of users and user groups. Every user is automatically assigned a unique identifier, which is used by the EFM Client to limit the scope of the activities a given user can perform. This invention allows for the creation and management of different types of domains and users. This invention accommodates a hierarchy. For instance, a system administrator creates and manages domains. Domain administrators create and manage different types of users and users groups. Administrative users also decide which users in a given domain can collaborate with users from other domains. Thus only a user-determined portion of any domain is exposed to other domains, limiting the points through which one domain can interface with another. This improves the security of both systems.

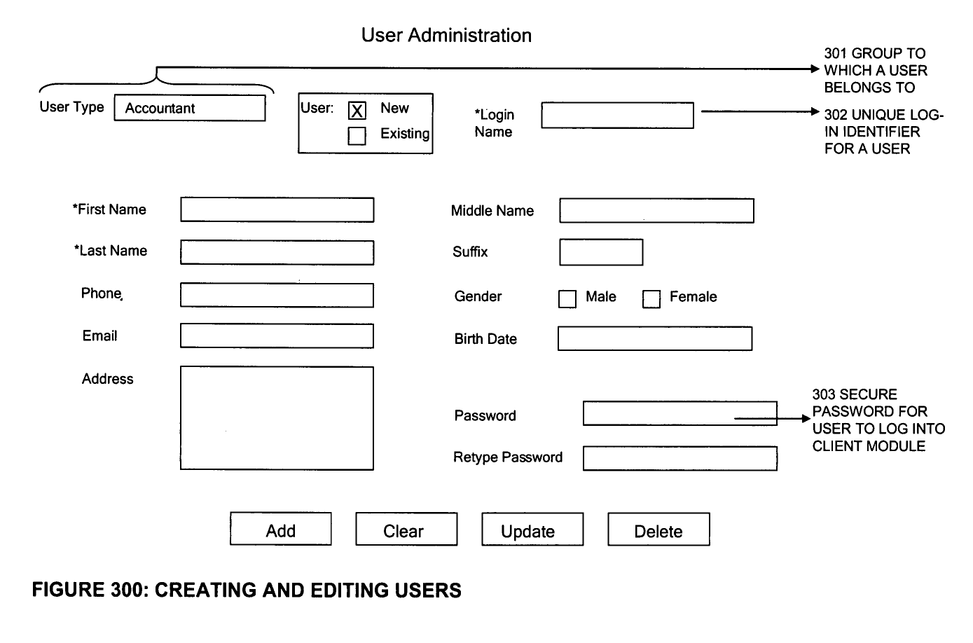

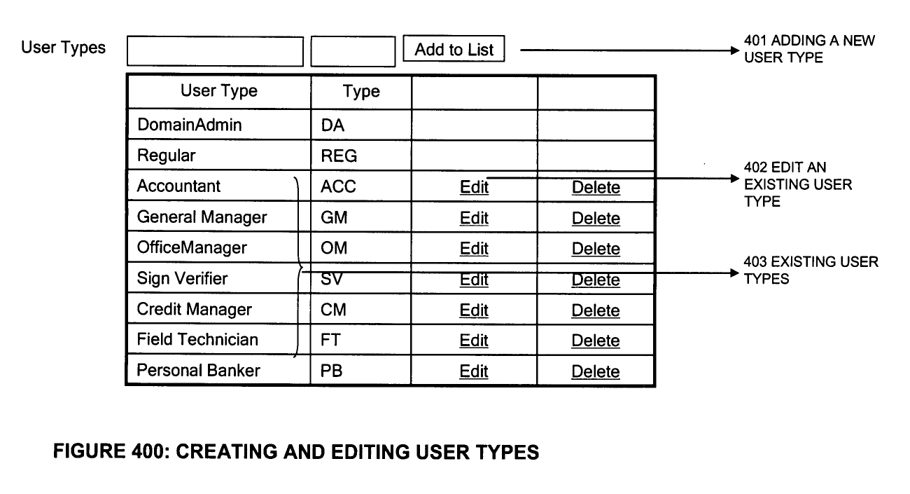

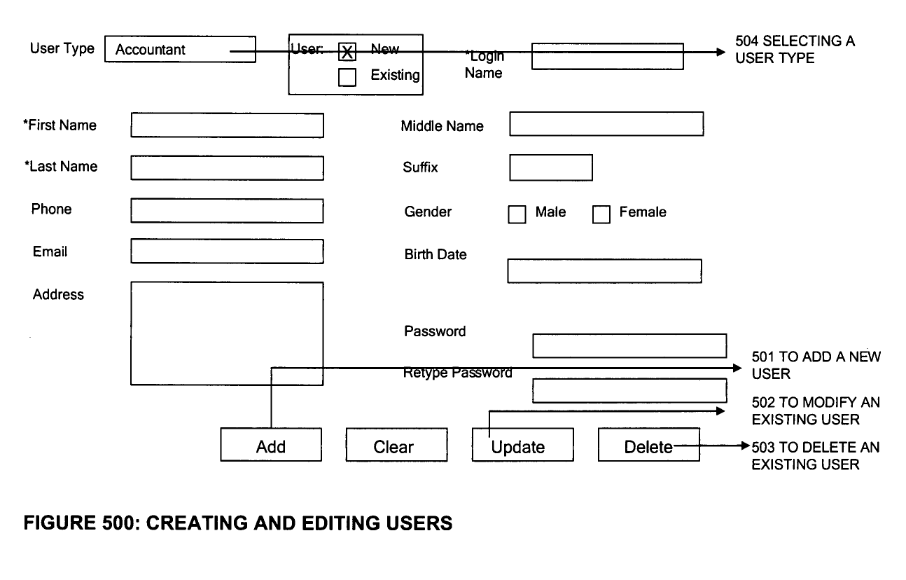

Methods 1505, 1506 and 1507 (in FIG. 1500) are called by the Configuration Client to create users, user groups and domains respectively. Refer to FIGS. 300 through 500 to view the interface provided for creation and management of users and user groups. This information is stored in the Configuration Server.

Step 2: Build Form Templates

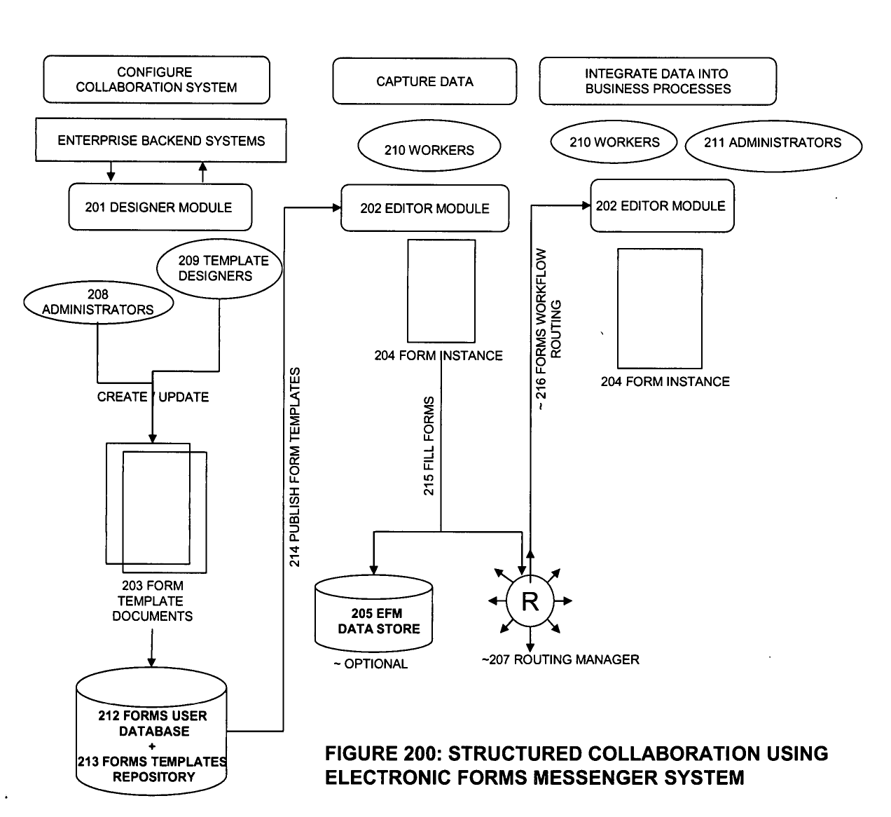

Referring now to FIG. 200, the manner in which the configuration client and the EFM client interact to enable structured communication and collaboration is depicted. The configuration client is used to configure a collaboration session by using electronic form templates to collect and process different kinds of information. A Forms Designer Module 201 is used by an administrative, template, (or other) user 208 and 209 respectively, to build form template documents. In other embodiments, the form template documents or partial form template documents can be built automatically by the configuration client (or other module) based on historical information and/or current information provided to at least one of the modules in the system. One of the most essential aspects of creating a form template 203 is the creation of form fields. The user may create as many fields as desired, and position them at any desired location. The user can create a variety of fields to capture different types of information. In an embodiment, the following are some of the different types of fields available to the user:
1. TextBoxes: to accept text type data
2. Multiline Text boxes: to accept multiple lines of text data
3. DateTime: to accept date and time
4. Date: to accept date
5. Time: to accept time
6. Table: to accept data in a tabular format
7. Numeric: to accept numeric values
8. Percentage: to accept percentage values
9. Currency: to accept currency values
10. Select controls: allow users to make one or more selections from a list of possible choices. The interface may differ, enabling users to signal their choice by clicking a radio button, checking a check box, or selecting an option from a drop down list.
11. Signature field: to accept a digital signature (in text form or in free form digital ink)
12. Picture: to accept electronic images

In an embodiment of the invention, the user indicates the type of field he wishes to create by “clicking a button” (each type of field is represented by a different button) and by clicking at a desired position to insert a blank field of the type selected at that spot. The user may move a field to any location, or rotate it to any position.

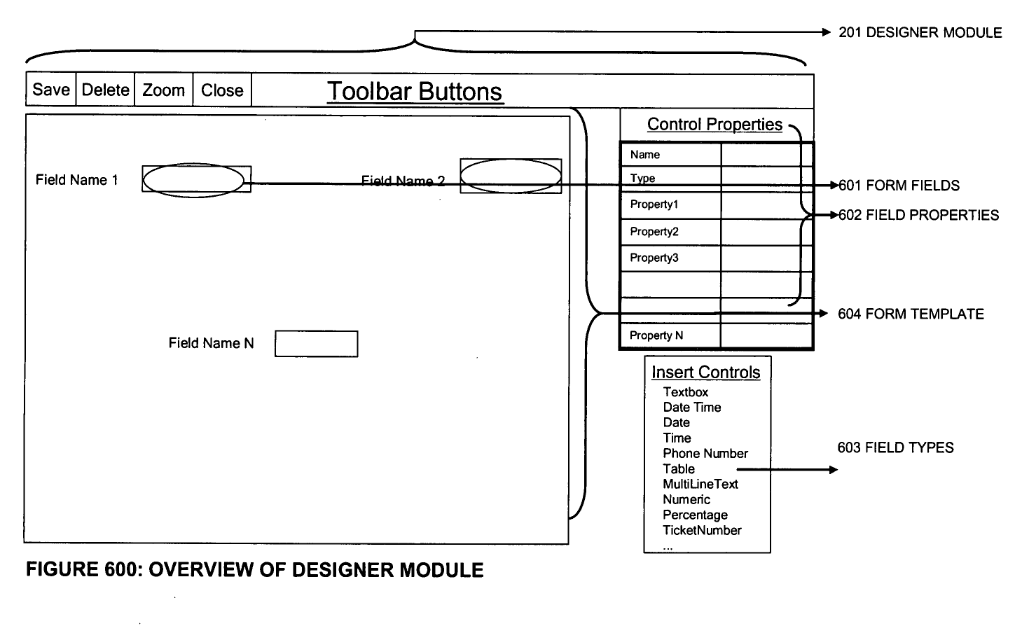

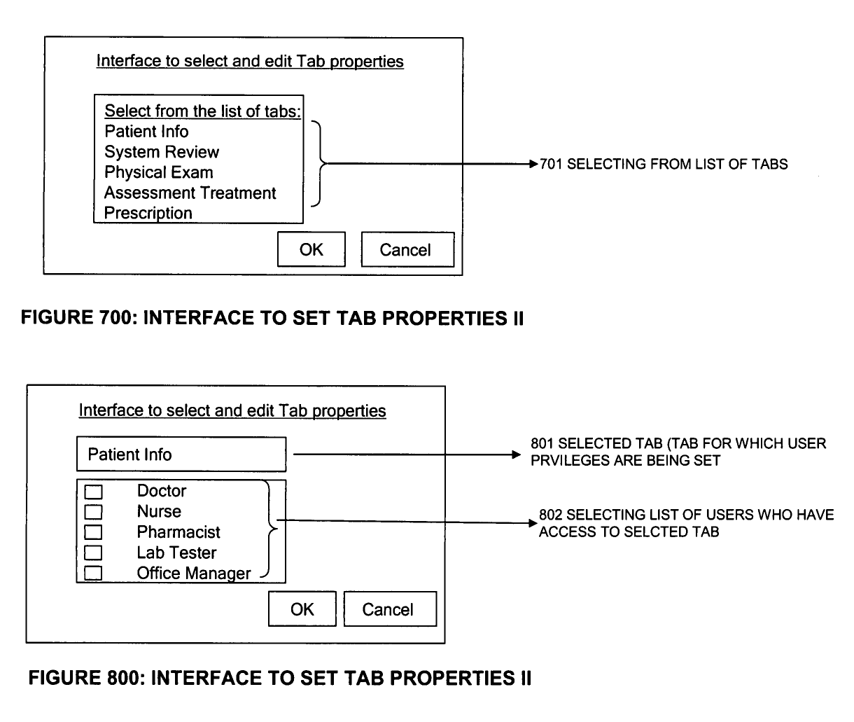

Setting field properties: The next step is to specify the validation rules to be applied to the data input by the user. Validation rules are enforced through manipulating one or more properties associated with a field. Each field has several properties, whose number and kind varies based on the type of field. Some properties are:
1. Field Name: Unique identifier for a field
2. Font: to specify font style, size, color etc.
3. Help Text: to display a tool tip to assist the user when filling the form
4. Location: (X,Y) Cartesian coordinates of the position of the field on the screen in terms of pixels
5. ReadOnly: if the field is a “read only” field. If yes, then the field will not allow the user to input data.
6. Height and Width: Specify the dimensions of the field in terms of pixels
7. MaxValue: the maximum acceptable value (for numeric, currency and percentage fields)
8. MinValue: the minimum acceptable value (for numeric, currency and percentage fields)
9. Formula: to perform automatic calculations based on values held by two or more fields (e.g.: Amount=Price X Units). This field enables users to organize form fields into one or more tabs or pages. When form fields are this grouped, it is easier to administer user privileges and routes for groups of form fields. Refer to FIG. 600 to see the user interface provided in an embodiment of the Designer Module.

Note that the Designer Module 201 enables users to create form templates from a new document or from an existing document (an MS Word® document, and Adobe® PDF file or a scanned image of a paper form). This capability enables users to create form templates that closely simulate the experience of using the form templates they are already familiar and comfortable with.

Step 3: Configure EFM System

Once a form template has been created, the next step is to publish it. Publishing 214 causes the template to be stored in a central location (locally or remotely on a server) 205 and be made available for consumption. In an embodiment, whenever a form template is published, the Configuration manager builds a template capsule, which contains the form template, along with configuration information associated with that template, if any. In an alternate embodiment, the publishing step is carried out first, and is followed by the capsule building step.

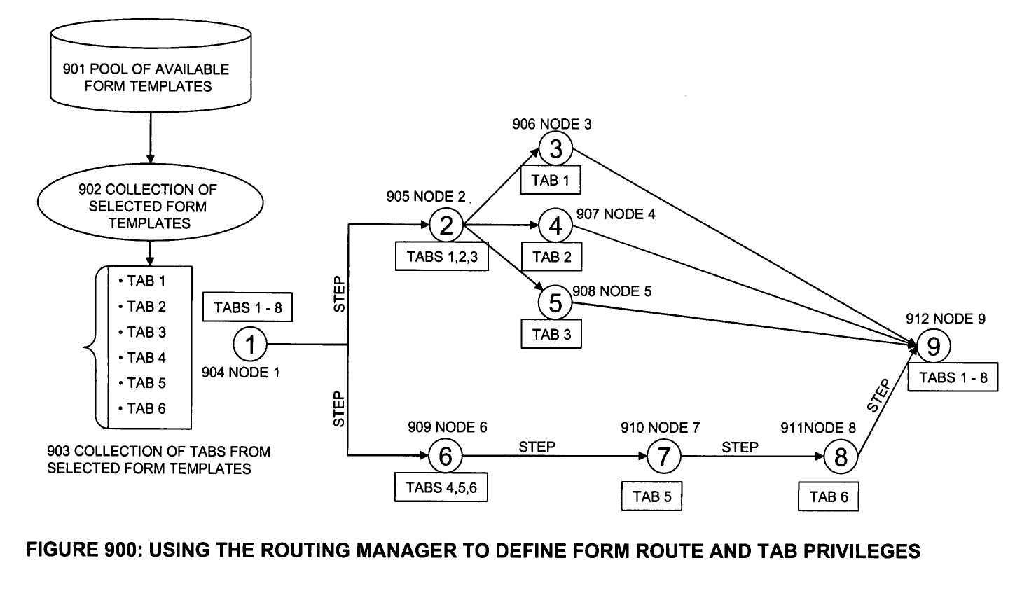

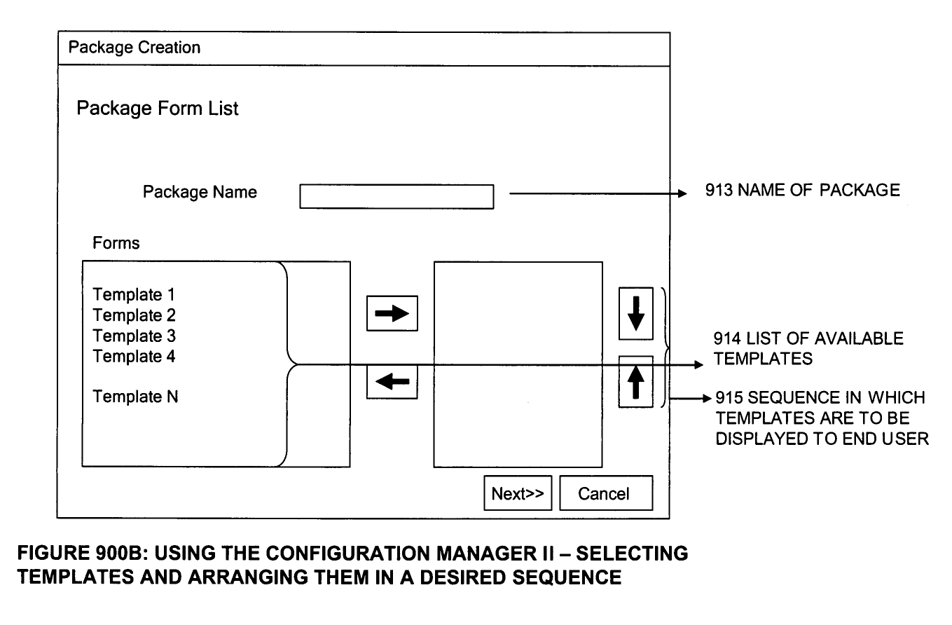

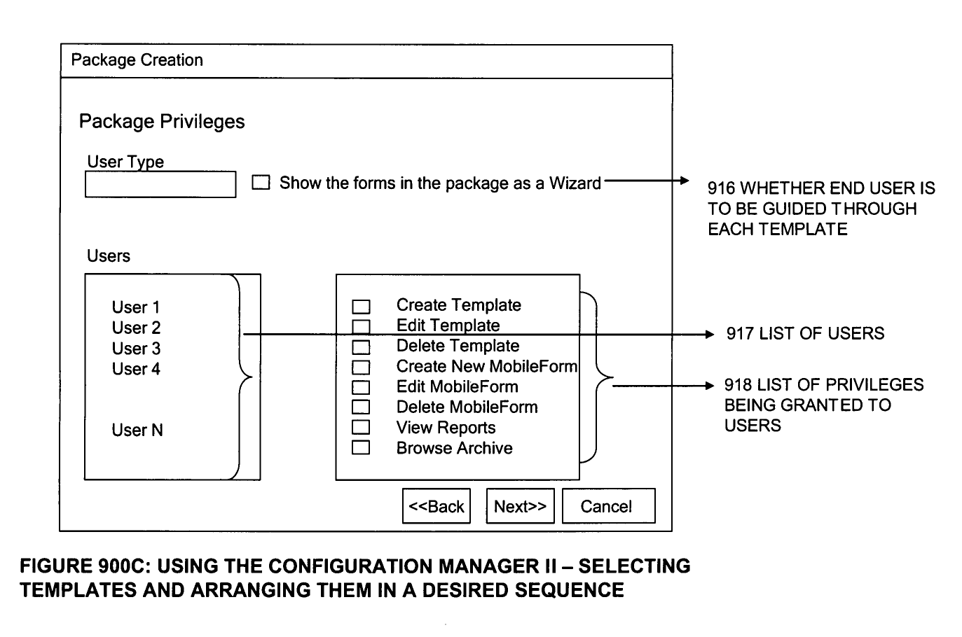

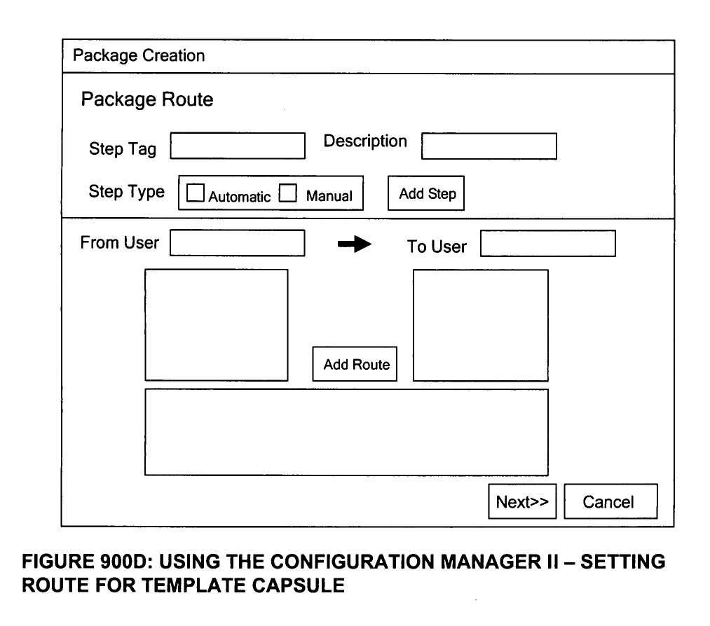

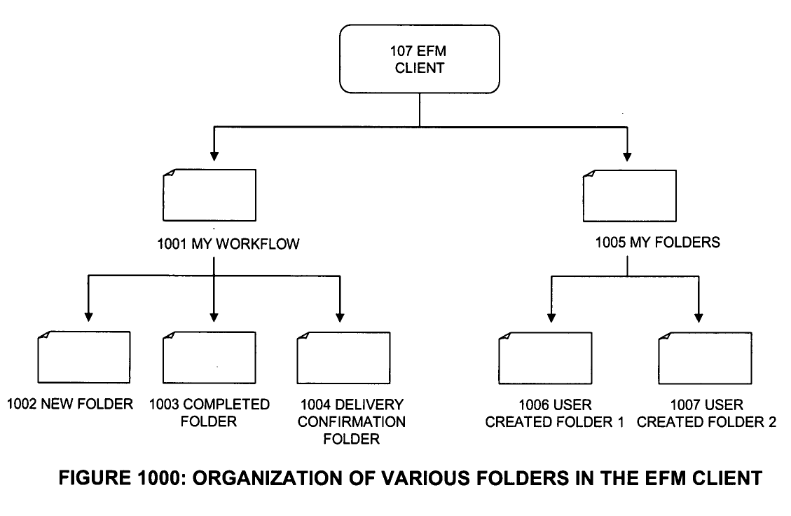

The Configuration client is then used to select the list of users who are to have access to the template capsule. Copies of the capsule are downloaded by the EFM Client into the EFM Client modules of individual users. As it can be seen from FIG. 900B, a template capsule is a collection of more than one template. The sequence in which different templates are to be displayed to the end user can be configured in advance. Users can either view one template at a time, or they can be guided through different templates. In FIG. 900C, the user configuring the system can be used to indicate whether the various templates that constitute a template capsule are to be presented to the user in the form of a “wizard”, where end users are guided through each template in a step by step manner. This method is desirable to control the environment in which data is captured, making the process of data collection as easy as possible for the end user. When the wizard option is checked, the different form templates are presented to the end user in the sequence indicated on FIG. 900B. The capsule once created is passed from the Configuration Client to the Configuration Server, which then stores the capsule on the EFM data store.

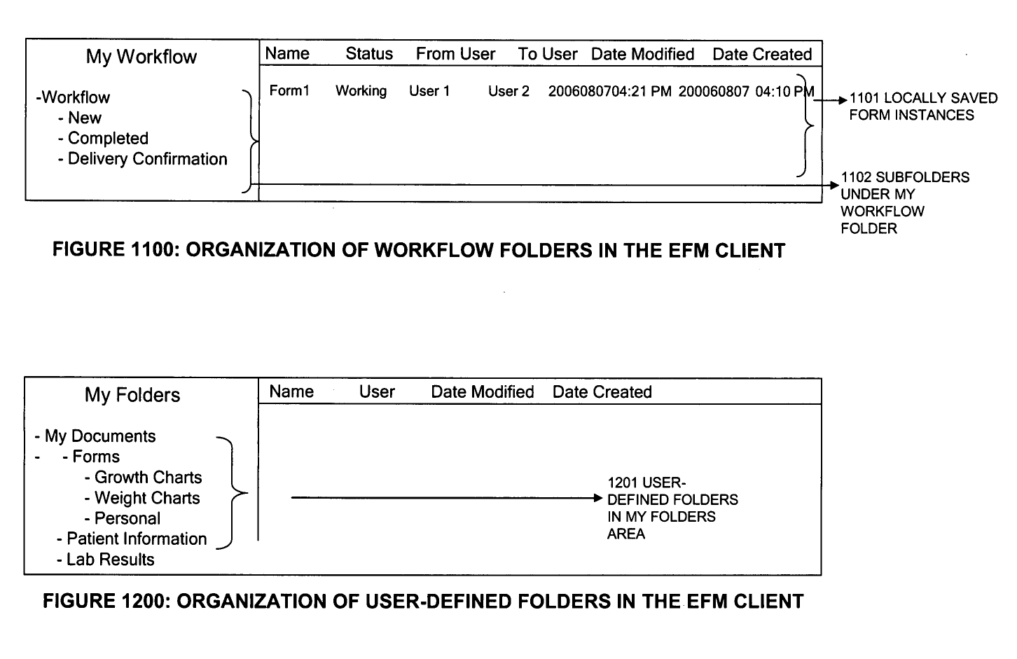

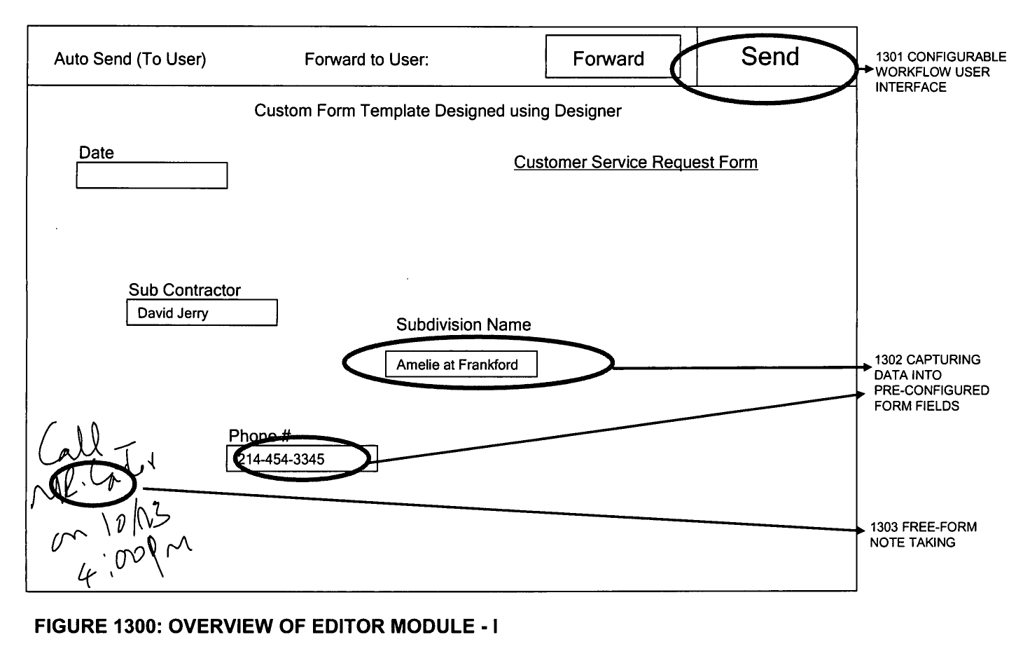

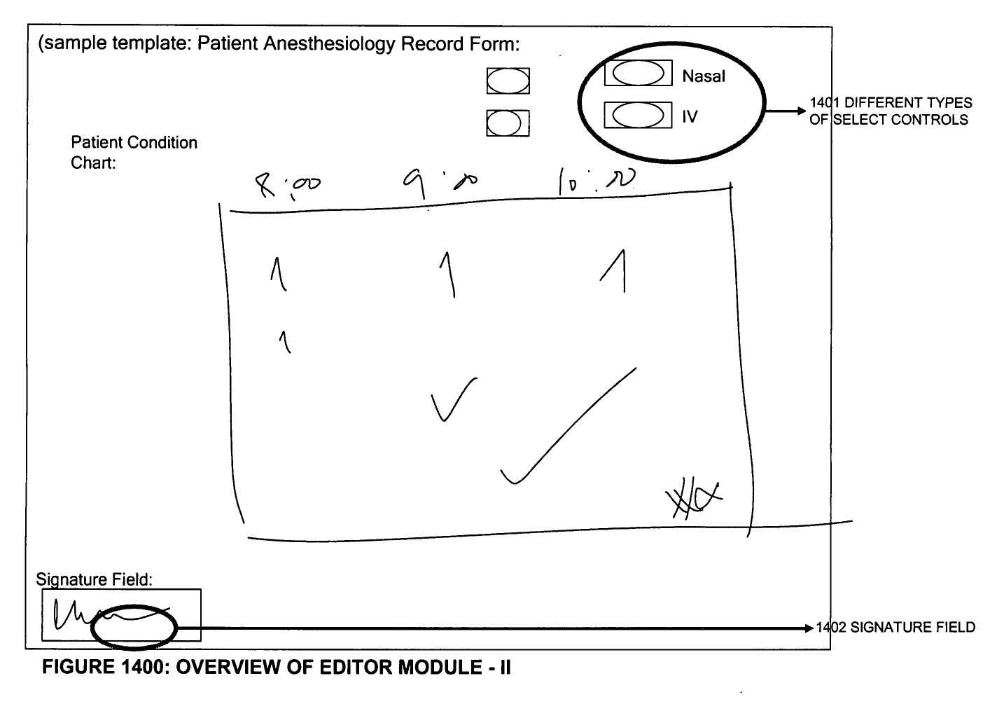

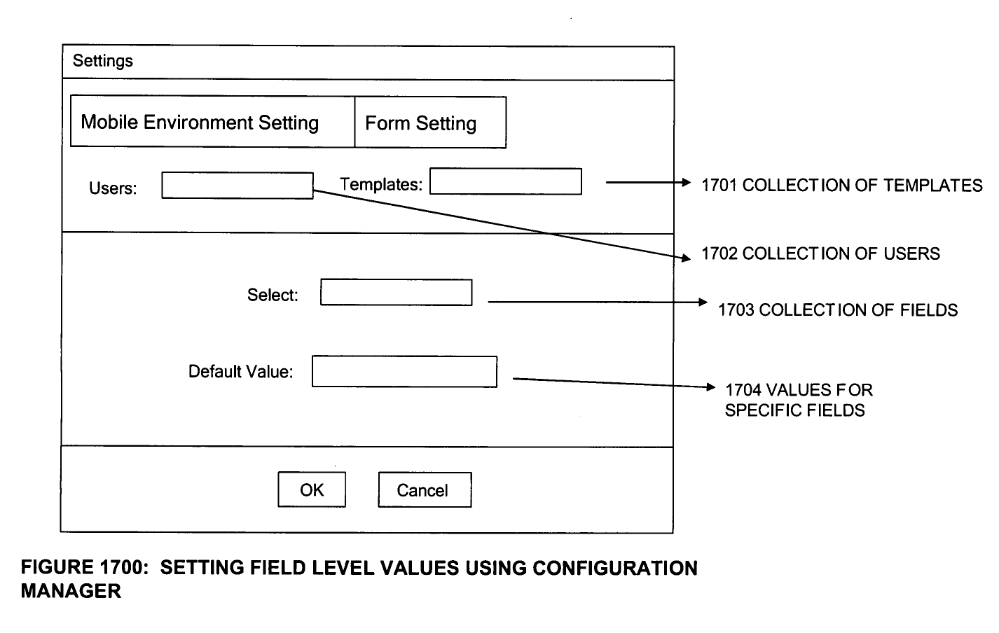

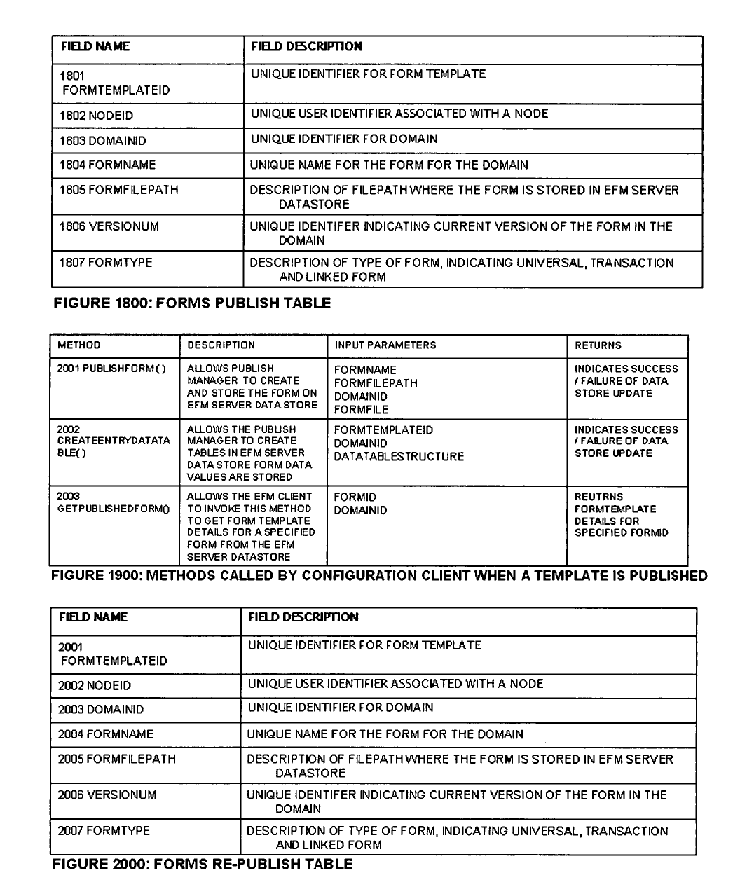

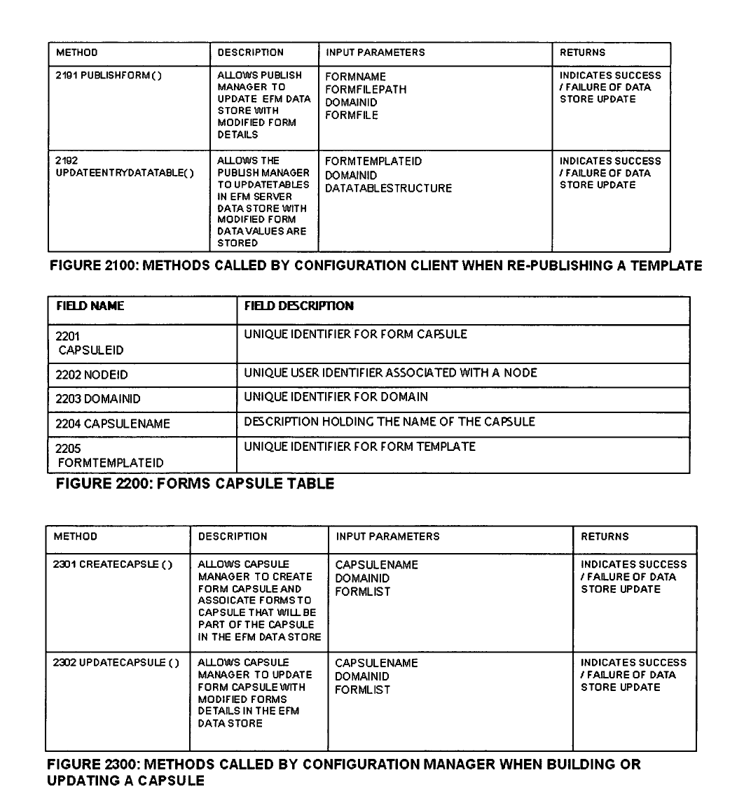

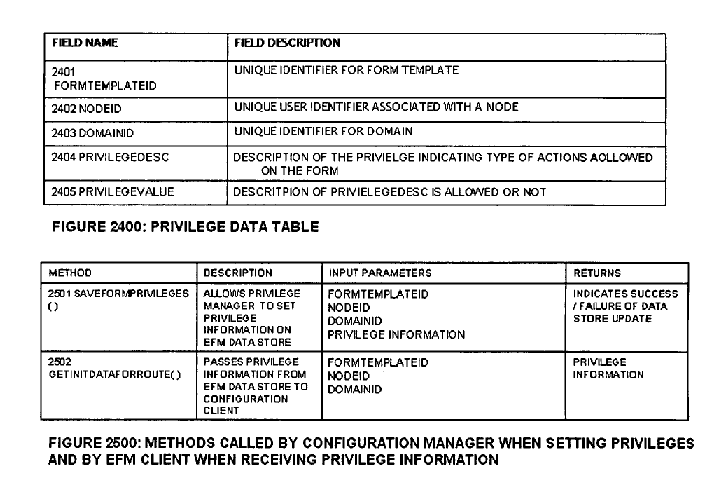

The Configuration manager module of the Configuration client is used to configure the EFM system. The following parameters can be configured by an admin user for a given form template:
Values for desired form fields in a form template. Refer to FIG. 1700 for a pictorial representation of the user interface provided by this invention to set default values at a field level.
Workflow definition: Route to be followed by a form instance during its lifecycle—which user will launch a form instance, and to which users must the instance be delivered to and in what sequence so that all the users along the path have the ability to provide their inputs. For instance, a loan application form instance may be launched by a personal banker, be passed to a credit manager for his approval, to the cashier if the loan has been approved and finally archived into the database. Refer to FIG. 900D to view the user interface provided in an embodiment to set routes.
User privileges: the administrator user can specify whether specific parts of a given form template are to be accessed by a given user or user group. Refer to FIG. 900 C to view the interface provided in an embodiment to set user privileges for a selected form template or group of templates (organized into a template capsule).
Organization: The way instances are stored in the EFM Client can be configured. FIG. 1100 shows the default folders under which the EFM client stores local instances. If a given end user has access to more than one capsule, then the instances can be organized by each capsule, and by values in specific fields within the templates in those capsules. For example, if User A has access to two template capsules—a sale order capsule and an inventory capsule, each composed of three templates each, then the ‘New’ folder in ‘My Workflow’ folder for User A will be composed of two sub folders, one each for each template capsule. By default, individual instances are organized according to the date and time of creation of that instance. Alternatively, users can organized them as per values in specific form fields. For instance, instances under subfolder for the sale order capsule can be organized by name of customer, size of order, etc., while the instances for the inventory capsule can be organized as per product name, number of available units, reorder date, etc. The sorting criteria mentioned—name of customer, size of order, product name, number of available units, reorder date, etc.—are all form fields.

The rules specified in the capsule are applied to all form instances created using the templates within a given capsule going forwards. Whether a given tab is to displayed to a specific user, what is the destination of a given form instance at any point along the path, etc. are all determined on the basis of the configuration information stored as part of the capsule. If there is a change is required either at the form template level or to the configuration settings, the Configuration Manager is used to edit existing capsules. Thus form templates need not be recreated every time a small change needs to be implemented. This allows enterprises to easily adapt applications to changing business needs, without having to re-develop applications from scratch.

Configuration Manager

In an embodiment, the Configuration manager is used to build a capsule that is composed of one or more form templates, along with the routing information and privileges associated with different tabs of the form templates. The template capsule is delivered to different users in the system, while the rest of the information is stored on the EFM Data store. In an embodiment, the Configuration Manager has a wizard interface, which guides the users through the various steps of configuring the EFM System, which are as follows:

Step 1: Select templates

Step 2: Determine user privileges

Step 3: Set default values for form fields

Step 4: Set workflow route

Select Templates

In order to build a template capsule, the user is required to indicate one or more templates which are contained in the capsule. This invention allows users to encapsulate more than one template at a time. The user also has the option to arrange these templates into a desired sequence according to which the templates are to be displayed to the end user via the EFM Client. Refer to FIG. 900B to see the user interface provided to select and sequence template documents.

Setting User Privileges

Once the templates have been selected, the next step is to determine which user has what level of privileges. For each of the selected templates, the Configuration manager can be used to grant or deny privileges to different users or user types. A user who does not have edit privileges to a given template will only be able to view the contents of an instance created using that template, but be unable to edit or alter the data in any way. Some users can create new instances, while others can only edit existing instances, while yet others can do both. These privileges are enforced by the end users' EFM Client modules.

Setting Default Values for Form Fields

This invention enables users to specify default values for specific form fields within the templates belonging to a capsule. The interface that enables users to set such field level default values is depicted in FIG. 1700.

Setting Workflow Route

Setting a workflow route for a template capsule comprises the following steps:

Step 1: Selection of template capsule

Step 2: Node definition

Step 3: Definition of steps

Step 4: Definition of tab privileges

Selection of form Templates:

The first step of defining a workflow is to select the desired template capsule for which is being configured. When the user selects the capsule, all the templates, as well as all the individual tabs for each of those templates are listed separately.

Node Definition:

The next step is to identify the users or user groups who are to receive the different tabs as the form follows its life-cycle. The Configuration manager provides a list of users and user groups available. The user designing the workflow can then proceed with identifying a subset of users/groups from this list. Any one from this subset may be designated as a node. It is important to remember users can belong to more than one domain. Users belonging to different domains can be brought up by identifying the domains to which they belong to from the list of domains provided by the Configuration manager. Note that only those users who have the privileges to collaborate with users from outside their respective domains will be listed by the Configuration manager. This ensures that the interfaces between domains are controlled and security is not compromised.

Definition of Steps:

Once the nodes have been identified, the next task is to define the steps of the workflow. A simple serial workflow may look like this: Node1^{step1}>Node2^{step2}>Node3^{step3}>Node4. While nodes identify sources and destinations, steps identify the sequence in which those nodes occur along a form's path.

Definition of Tab Privileges:

The next step is to associate each node with one or more tabs and to specify the tab privileges. Associating a tab with a node tells the Configuration manager what tab the user belonging to that node can send or receive. The tab privileges tell the EFM Client what nature of the access to be allowed to a user for a given tab. As we saw earlier, tabs can have one of three privileges: editable, read-only or invisible. Refer to FIG. 900A to see a pictorial representation of the different steps taken to define the workflow and tab privileges.

The Configuration manager builds a capsule file that contains the form templates, the route to be taken by different tabs of the component forms, and the degree of privileges associated with each tab. This capsule is stored by the Configuration Server into the EFM Data Store. Copies of the form template are delivered to individual end users via the EFM Server and Client (based on whether or not they have rights to access a given template). It is important to note that the routing information is not transported along with the template. Form instances are created using the Forms Editor Module of the EFM Client. In an embodiment, the user clicks a ‘send’ or ‘submit’ button. This causes the EFM Client to pass the capsule to the EFM Server. The EFM Server refers to the configuration data for that template stored in the EFM data store and directs the capsule to the next recipient in the route.

It is important to note that form routes once set can be altered any later point. The user can access the capsule created by the Configuration manager, and change the nodes, routes, or tab privileges. Since the capsule resides on the server, it is not required to broadcast changes to individual users. All forms are routed via the server, and if there is an altered form route, any form received by the server will be directed to its new route by the Configuration manager. This capability makes change management simple and efficient. Thus businesses can quickly adapt to changes without having to invest in developing new applications.

Step 4: Capturing, Validating and Exchanging Data

Once a form capsule has been created and configured, the next step is to use the templates to capture and process data. The various steps involved are:

Step 1: Receive template capsules and configuration information

Step 2: Create form instance/Receive form instance

Step 3: Submit form instance

Step 1: Receiving Form Templates and Configuration Information

The template capsules and associated configuration information are delivered to individual end users via the EFM Server and Client. In an embodiment, the user performs a ‘synchronize’ operation through the EFM Client module. In alternate embodiments, this action can be automatically performed by the EFM Client whenever it detects a connection with the EFM Server. During the synchronize operation, the EFM Client module connects with the EFM Server. The EFM Server checks the EFM Data Store for any updates for that User. If there is a template capsule, this capsule, as well as associated configuration information (pre-set field level data, user rights for different tabs, etc.) are passed from the EFM Data Store to the EFM Client and stored into the EFM Client side cached data store.

Step 2: Create Form Instance/Receive form Instance

Once a given user has received a template capsule, he or she can create instances of the templates contained in that capsule. In an embodiment, the Editor Module automatically launches an instance of a template (if the user has create rights for that template). Users capture information using this instance.

Automatic advancement through multiple templates: If the capsule is composed of more than one template, the user is either lead through each one according to a pre-specified sequence (specified at the time of building the template capsule), or allowed to access the templates in any desired order. If the user is to be walked through the different templates according to a pre-determined sequence, the Editor Module displays the different tabs as per this order.

The Editor Module is responsible for enforcing the different business rules as specified using the Configuration Client. The Editor Module reads the configuration information associated with the form template and determines which tabs and fields within those tabs are to be available for access by a given user. If a form field has field level user validation rules (for e.g.: Field A is a mandatory field/Field B cannot hold a value less than 100), these rules are enforced by the Editor.

In an embodiment, the EFM Client saves all instances under the ‘New’ folder in the My Workflow set of folders. If a set of custom folders for different templates capsules was configured, then instances are stored into those folders, and organized as per the specified sorting information, if any was specified at the time of building the capsule. When the user wishes to transmit the instance to the next user along the route, the user moves the instance to the ‘Completed’ folder.

Step 3: Submit Form Instance

Once the user has completed his part, the instance is then sent to the next user in the capsule's route. In an embodiment, when users are ready to send the instance to the next user, they click a ‘Send’ button. Alternatively, they can also press a ‘Synchronize’ button. This causes the EFM Client to pass all instances stored in the ‘completed’ folder to the EFM Server. The EFM Server checks the configuration information for that template from the EFM Data Store. If the form is to be received by user A, it updates the status of the form as being ready for download by user A. Whenever user A's EFM Client next connects with the EFM Server, the form along with the associated configuration information is passed to user A's EFM Client.

Note that if data for a mandatory form field has not been supplied, the Editor Module communicates this to the EFM Client, which prevents the transfer of the instance to the next node, until this required piece of information has been supplied.

Enterprises can thus create custom form templates using the Designer Module, and incorporate business rules such as complex workflow using the Configuration Client. They accomplish all of this without writing a single line of custom code.

Making Changes to Templates/Configuration Settings

If an enterprise wishes to change the contents of a template (for example: add an additional field to a given form template or remove an existing one), or to the route followed by a template by including a new employee in the route, the change can be made using the Configuration client. The updates are automatically transmitted to every EFM Client involved during the next synchronize operation. The entire application need not be re-developed.

Also, the EFM system proposed by this invention is ideal for mobile workers. The EFM Client operates in both online and offline modes. The mobile worker needs to connect to the EFM Server only when he is sending or receiving forms. He can create and fill form instances even when he is not connected to the EFM Server. Thus a mobile worker can capture information in environments where he has poor or no connectivity to his office.

### CONCLUSION

Frustrations and inefficiencies relating to paperwork cost enterprises billions of dollars every year. Some of the main challenges faced by businesses include delays due to physically moving paperwork, errors due to manual data entry, expenses relating to non-compliance, lack of security, manual re-entry and rework.

The electronic forms messenger system proposed by this invention offers the power of a custom application, combined with the familiarity of using paper forms and pen, and the simplicity and affordability of an email platform. Implementing this system allows businesses to greatly reduce upfront investments on developing custom applications. The system is completely configurable and based on a “Zero Programming” model. Further, by allowing them to carry forward existing forms, it ensures that users are familiar and comfortable with the interface. Embedded intelligence reduces errors and ensures security, and high quality of data captured using the form templates. The EFM system also connects with databases, and other applications, not just users within and outside an organization.

This invention enables enterprises to:
Capture—Accurately gather data
Manage—Organize, handle and distribute data efficiently and securely
Communicate—Relay data between various user groups securely
Collaborate—Provide efficient and highly reliable channels for data to be shared between various groups for real time decision making
Track—Accurately manage and trace all documents and tasks in process workflows
Store and retrieve—Efficiently and securely archive business information for historical value
Audit—Provide accurate reporting for internal and external purposes
Comply with regulations—Establish and monitor business operations to comply with all legal and regulatory requirements
Automate—Establish highly optimized business processes by use of technologies to improve resource and system productivity

Thus this invention fulfills its stated objective of enabling structured communication and collaboration in enterprises.

Programming techniques may vary, and the above description of the modules of the invention should be considered illustrative, and not in a limiting sense. For instance, a different set of names may be employed for the features and modules, without departing from the scope of this invention. A number of steps have been described in this invention. It is important to note that the same steps could be performed in a different sequence without departing from the scope of this invention.

Although the invention has been described with reference to a particular embodiment, this description is not meant to be construed in a limiting sense. Various modifications of the disclosed embodiments as well as alternative embodiments of the invention will become apparent to persons skilled in the art upon reference to the description of the invention. It is therefore contemplated that the appended claims will cover any such modifications or embodiments that fall within the scope of the invention.

What is claimed is:

1. A system, comprising:
a configuration client;
a configuration server communicably coupled to the configuration client;
an electronic forms messenger (EFM) client;
an EFM server communicably coupled to the EFM client;
a data store communicably coupled to the configuration server and to the EFM server;
wherein the configuration client is used to:
configure at least one of: the EFM client, the EFM server, and the data store; and
set various parameters and stores the parameters in the data store;
wherein the configuration server module accesses the stored parameters; and
wherein the EFM client is used to: download EFM templates, create and manipulate EFM instances as configured using the configuration client.

2. The system of claim 1, wherein the configuration client includes a forms designer module and a configuration manager.

3. The system of claim 2, wherein the forms designer module provides an environment in which EFM templates are designed.

4. The system of claim 2, wherein the configuration manager performs at least one of a following action:
allows workflow routes for EFM templates to be set;
directs completed forms between different users and user groups; and
creates and manages the users and the users groups, as well as privileges and rights associated with the users and the users groups.

5. The system of claim 1, wherein the EFM server and the EFM client are used by users to capture information using the EFM templates and to route the information amongst themselves.

6. The system of claim 1, wherein a user interacts with the system through the EFM client.

7. The system of claim 1, wherein the EFM client includes a forms editor module where instances of the EFM templates are created and populated.

8. The system of claim 1, wherein the EFM client organizes EFM templates and form instances under various folders.

9. The system of claim 1, wherein the EFM client passes a form capsule containing a form instance to the EFM server when a form is to be sent to or received from a user.

10. The system of claim 9, wherein the EFM server determines an identity of the user that is going to receive the capsule, wherein if the EFM server has one or more capsules available for the user, the EFM client of that user receives these capsules whenever it connects with the EFM server.

11. The system of claim 10, wherein the EFM server passes a form template and a template capsule to the EFM client when form templates are published.

12. The system of claim 11, wherein the configuration information for the form capsule and for the template capsule is stored on the data store which includes a list of users who are privileged to access a given capsule.

13. The system of claim 12, wherein the EFM server passes the capsules to the EFM client based on the configuration information associated with at least one of the capsules.

14. A computer readable medium comprising instructions for:
creating an electronic form template document, wherein the document includes:
at least one form field associated with a specific two dimensional spatial position in relation to a point of reference on the electronic form template document;
an indication whether none or one or more of the form fields are mapped to a primary data store; and
an indication whether none or one or more of the form fields are mapped to a cached data store.

15. The computer readable medium of claim 14 further comprising at least one of a following action:
viewing, manipulating and storing data in the form fields in the electronic form template document;
manipulating and storing data in the primary data store when the electronic form template document is in an online state;
receiving data from the primary data store for those form fields that are indicated to be cached, when the electronic form template document in an online state; and
viewing, manipulating and storing data in the cached data store when the electronic form template document is in an offline state.

16. The computer readable medium of claim 14 further comprising at least one of a following action:
creating the electronic form template document;
viewing the electronic form template document;
manipulating the electronic form template document; and
storing the electronic form template document.

17. The computer readable medium of claim 14 further comprising creating, viewing, manipulating, and storing the electronic form template document via an input.

18. A method for using an electronic form template document, comprising:
producing a first electronic form template document using a user-defined layout, the first electronic form template including:
a background reference document;
at least one form field associated with a specific two dimensional spatial position in relation to a point of reference on the background reference document;
none or one or more validation rules associated with the form field; and
producing at least one secondary electronic form template document with a user-defined layout distinct from the layout of the first electronic form template, wherein the secondary electronic form template further includes:
a background reference document;
at least one form field associated with:
a user-defined two dimensional spatial position in relation to a point of reference on the background reference document of the secondary electronic form template; and
a user-specified mapping between the form field in the secondary electronic form template and the form field in the first electronic form template.

19. The method of claim 18 comprising manipulating the first and the secondary electronic form template documents, wherein the manipulating includes at least one of:
displaying the first electronic form template document;
accepting at least one input value for one or more of the form fields in the first electronic form template document;
validating the accepted input value;
enabling a user to select one or more of the secondary electronic form template documents; and
displaying the accepted input value on every form field in the secondary electronic form template associated with the form field in the first electronic form template.

20. The method of claim 18, wherein data collected using one of the user-defined layouts is automatically displayed in a multiplicity of layouts.
